(19) United States
(12) Patent Application Publication
(10) Pub. No.: US 2014/0095788 A1
(43) Pub. Date: Apr. 3, 2014

(54) METHOD FOR VIRTUALIZING RAID OF COMPUTER SYSTEM

(71) Applicants: Chao-Chung Wu, Taipei City (TW); Ping Yuan, Taipei City (TW); Xiao-Jun Liu, Taipei City (TW)

(72) Inventors: Chao-Chung Wu, Taipei City (TW); Ping Yuan, Taipei City (TW); Xiao-Jun Liu, Taipei City (TW)

(73) Assignee: ASUSTeK COMPUTER INC., Taipei City (TW)

(21) Appl. No.: 14/028,519

(22) Filed: Sep. 16, 2013

Related U.S. Application Data
(60) Provisional application No. 61/706,792, filed on Sep. 28, 2012.

(30) Foreign Application Priority Data
Aug. 20, 2013 (TW) 102129866

(51) Int. Cl. G06F 12/00

(52) U.S. Cl. CPC G06F 12/00
USPC 711/114

(57) ABSTRACT

A method for virtualizing a redundant array of independent disks (RAID) of a computer system is provided. The computer system includes a plurality of storage devices and a central processing unit (CPU). The method includes following steps: establishing a storage device interface via the CPU after the computer system is powered on and a power-on self-test (POST) is executed, wherein the storage device interface integrates the storage devices into at least one RAID according to an array configuration; accessing the storage devices by the CPU via the storage device interface after the RAID is established; determining an access mode of the storage devices by the CPU according to a level of the RAID when the CPU receives an access instruction; and establishing a user interface by the CPU according to a system program of the RAID.

### CROSS-REFERENCE TO RELATED APPLICATION

This application claims the priority benefit of U.S. application Ser. No. 61/706,792, filed on Sep. 28, 2012 and Taiwan application serial No. 102129866, filed on Aug. 20, 2013. The entirety of each of the above-mentioned patent applications is hereby incorporated by reference herein and made a part of this specification.

### BACKGROUND OF THE INVENTION

1. Field of the Invention

The invention relates to a virtualizing method and, more particularly, to a method for virtualizing a RAID of a computer system.

2. Description of the Related Art

In a computer, multiple independent disks can be integrated to a redundant array of independent disks (RAID) to virtualize an independent disk with large volume or high security. Conventionally, the RAID can be achieved via a disk controller with an RAID function or a software RAID function provided by an operating system. However, the disk controller with an RAID function increases a hardware cost of the computer system, and the number of the disks (or storage devices) connected to the disk controller is limited by the controller. On the other hand, since the software RAID function provided by the operating system only can be used at the operating system, the disks (or the storage devices) in connection should be recognized by the operating system and be compatible with the operating system to use the function. In order to avoid an abnormal booting of the operating system, the software RAID function usually cannot be used to connect the disk with an operating system program to the RAID. Furthermore, the software RAID function cannot establish the RAID first and then install the operating system.

As stated above, the user usually selects a hardware manner (such as a disk controller with an RAID function) or a software manner (such as a software RAID function provided by the operating system or an application program) to establish the RAID according to users requirements. However, the manners may not satisfy the user requirements and limit the efficiency of the storage devices.

### BRIEF SUMMARY OF THE INVENTION

A method for virtualizing a RAID of a computer system is provided. In the method, a RAID is established via a firmware before an operating system is loaded, and thus the operating system can be installed after the RAID establishment, which does not increase hardware cost.

A method for virtualizing a RAID of a computer system is provided. The computer system includes a plurality of storage devices and a central processing unit (CPU). The method for virtualizing the RAID includes following steps: establishing a storage device interface via the CPU after the computer system is powered on and a power-on self-test (POST) is executed, wherein the storage device interface integrates the storage devices into at least one RAID according to an array configuration; accessing the storage devices by the CPU via the storage device interface after the RAID is established; determining an access mode of the storage devices by the CPU according to a level of the RAID when the CPU receives a storage device access instruction; and establishing a user interface by the CPU according to a system program of the RAID.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a computer system in an embodiment;

FIG. 2 is a schematic diagram showing access of a RAID in an embodiment;

FIG. 3 is a flow chart showing a method for virtualizing a RAID of a computer system in an embodiment; and

FIG. 4 is a flow chart showing a method for virtualizing a RAID of a computer system in another embodiment.

### DETAILED DESCRIPTION OF THE EMBODIMENTS

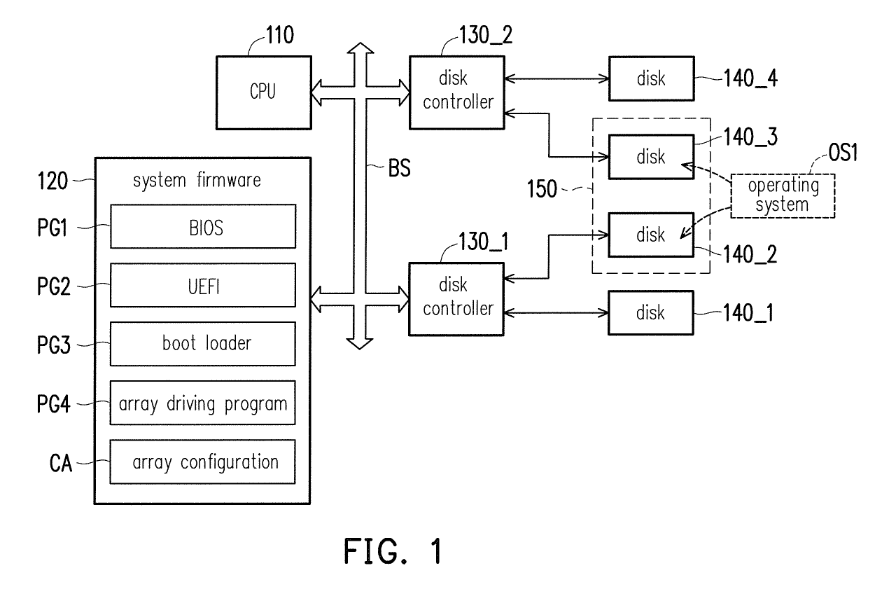

FIG. 1 is a schematic diagram showing a computer system in an embodiment. Please refer to FIG. 1, in the embodiment, the computer system includes a CPU 110, a system firmware 120, a plurality of storage device controllers (or storage device access interfaces, disk controllers 130_1 and 130_2 are taken as an example herein) and a plurality of storage devices (disks 140_1 to 140_4 are taken as an example herein). In the embodiment, the system firmware 120 includes several programs, such as a basic input/output system (BIOS) program PG1, an unified extensible firmware interface (UEFI) program PG2, a boot loader program PG3 and an array driving program PG4 (which corresponds to a first array driving program). The programs of the system firmware 120 can be adjusted according to circuit requirements. The system firmware 120 includes an array configuration CA to set the connection relation of the disks 140_1 to 140_4. When multiple disks are connected, they are integrated to a RAID. For example, the connected disks 140_2 to 140_3 are integrated to one disk (or the RAID) 150.

The CPU 110, the system firmware 120 and the disk controllers 130_1 and 130_2 are connected with each other via buses BS, which is not limited herein. After the computer system 100 is powered on, the CPU 110 accesses the BIOS program PG1 or the UEFI program PG2 of the system firmware 120 to execute a power-on self-test (POST).

When the CPU 110 executes the BIOS program PG1, the BIOS is launched, and the POST of the computer system 100 is executed via the BIOS. When the CPU 110 executes the UEFI program PG2, an UEFI is launched, and the POST of the computer system 100 is executed via the UEFI. The POST may be executed via other programs, which is not limited herein.

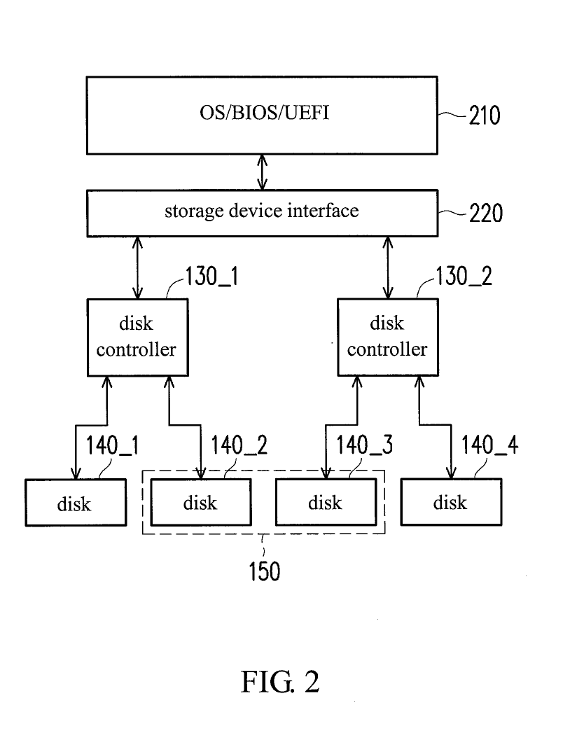

FIG. 2 is a schematic diagram showing access of a RAID in an embodiment. Please refer to FIG. 1 and FIG. 2, in the embodiment, when the computer system 100 finishes the POST, a storage device interface 220 is established via the CPU 110. The storage device interface 220 can integrate the storage devices (such as the disks 140_1 to 140_4) to at least one RAID 150 according to the array configuration CA of the system firmware 120.

Furthermore, after the computer system 100 finishes the POST via the BIOS or the UEFI, the CPU 110 can execute the boot loader program PG3 of the system firmware 120 to launch a boot loader and initialize the computer system 100 via the boot loader. At the moment, when the boot loader program PG3 is executed, the boot loader accesses and executes the array driving program PG4 via the CPU 110. The array driving program PG4 establishes the storage device interface 220 according to the array configuration CA of the system firmware 120.

In the embodiment, the CPU 110 may scan the storage devices (such as the disks 140_1 to 140_4) via the storage device interface 220 to confirm device information of the storage devices (such as the disks 140_1 to 140_4). Then, the CPU 110 accesses the array configuration CA and confirms whether the storage devices (such as the disks 140_{—} 1 to 140_4) are recorded in the array configuration via the device information of the storage devices. When the storage devices (such as the disks 140_{—} 1 to 140_4) are recorded in the array configuration CA, the CPU 110 sets a connection relation of the storage devices (such as the disks 140_2 and 140_3) according to the array configuration CA to integrate the storage devices (such as the disks 140_2 and 140_3) to form the RAID 150. When the storage devices (such as the disks 140_1 to 140_4) are not recorded in the array configuration CA, the CPU 110 regards the storage devices (such as the disks 140_1 and 140_4) as an independent storage device.

After the RAID 150 is established, the CPU 110 communicates with the storage device controller (such as the disk controllers 130_1 and 130_2) via the storage device interface 220. That is, a managing program 210 (such as the BIOS or the UEFI) can communicate with the storage device controller (such as the disk controllers 130_1 and 130_2) via the storage device interface 220 to make the CPU 110 access the storage devices (such as the disks 140_1 to 140_4) via the storage device interface 220. When the CPU 110 receives an access instruction of the storage devices, the CPU 110 determines an access mode, such as the RAID 0, the RAID 1, the RAID 10 or the RAID 01, of the storage devices (such as the disks 140_1 to 140_4) according to a level of the RAID 150. Then, the CPU 110 establishes a user interface according to the system program (such as an operating system OS1) of the RAID 150.

In the embodiment, the operating system OS1 may be stored in the RAID 150 including the disks 140_2 and 140_3, and thus the boot loader PG3 can control the CPU 110 to access and execute the operating system program of the RAID 150 via the storage device interface 220 to launch the operating system OS1. When the operating system program is executed by the CPU 110, the operating system OS1 accesses and executes another array driving program (which corresponds to a second array driving program) via the CPU 110 to manage the access of the storage devices (such as the disks 140_1 to 140_4). The array driving program establishes the storage device interface 220 according to the array configuration CA of the system firmware 120 or another array configuration CA′ (which may be stored in the RAID 150 and has a same configuration method with the array configuration CA), and it maintains the storage device interface 220 via the CPU 110. The operating system (which is the managing program 210) still accesses the storage devices (such as the disks 140_1 to 140_4) via the storage device interface 220. Thus, the operating system OS1 still takes the disks 140_2 and 140_3 as the RAID 150, which avoids that the operating system OS1 cannot operate.

As stated above, when the computer system 100 finishes the POST, it launches a boot loader via the CPU 110, and the boot loader accesses and executes the array driving program PG4 via the CPU 110 to establish the storage device interface 220 corresponding to the array configuration CA via the PG4. Thus, the RAID is established via the system firmware 120, which meets the user requirements and improves efficiency of the storage devices.

In the embodiment, the boot loader accesses and executes the array driving program PG4 via the CPU 110. In other embodiments, the BIOS or the UEFI accesses and executes the array driving program PG4 via the CPU 110, which is not limited herein. In other words, when the BIOS program PG1 or the UEFI program PG2 is executed, the BIOS or the UEFI accesses and executes the array driving program PG4 via the CPU 110 to establish the storage device interface 220 corresponding to the array configuration CA of the system firmware 120 via the PG4. The boot loader program PG3 may be stored in the system firmware 120 or the RAID 150, which is not limited herein.

Since the requirements of the computer system 100 may be different, only one of the BIOS program PG1, the UEFI program PG2 and the boot loader program PG3 may be executed. The execution of the BIOS program PG1, the UEFI program PG2, the boot loader program PG3 and the array driving program PG4 can be referred to that in the previous embodiments, which is omitted herein.

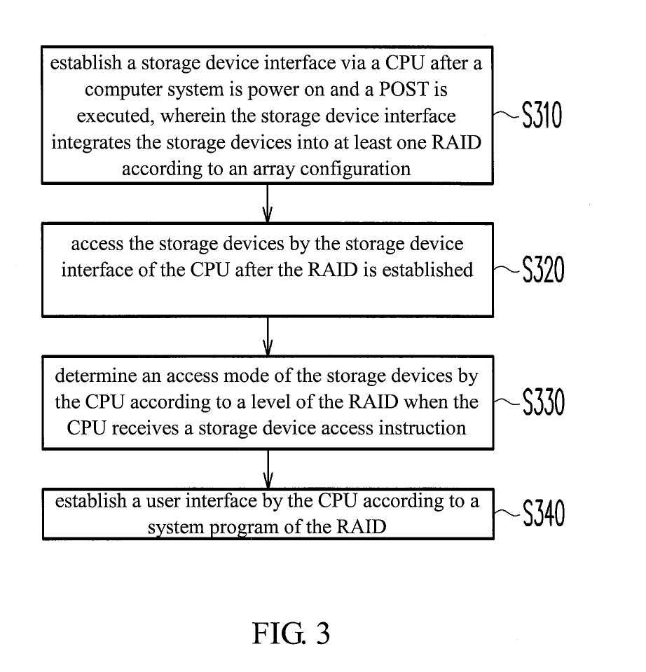

FIG. 3 is a flow chart showing a method for virtualizing a RAID of a computer system in an embodiment. Please refer to FIG. 3, in the embodiment, the computer system includes a plurality of storage devices and a CPU. The method for virtualizing the RAID of the computer system includes following steps: establishing a storage device interface via the CPU after the computer system is powered on and a POST is executed, wherein the storage device interface integrates the storage devices into at least one RAID according to an array configuration (step S310); accessing the storage devices by the CPU via the storage device interface after the RAID is established (step S320); determining an access mode of the storage devices by the CPU according to a level of the RAID when the CPU receives a storage device access instruction (step S330); and establishing a user interface by the CPU according to a system program of the RAID (step S340).

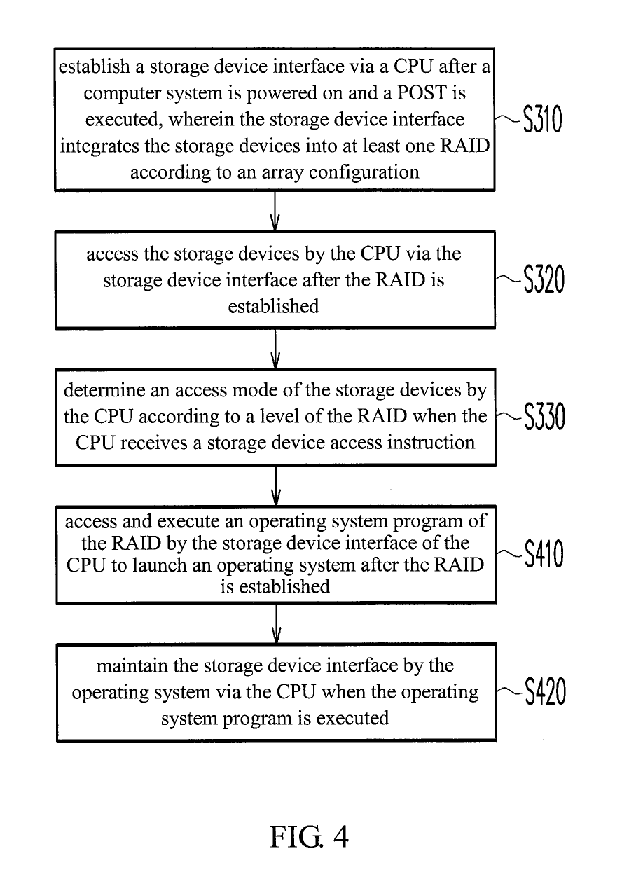

FIG. 4 is a flow chart showing a method for virtualizing a RAID of a computer system in another embodiment. Please refer to FIG. 3 and FIG. 4, in the embodiment, the method for virtualizing a RAID of a computer system further includes steps S410 and S420, and the same or similar symbols denote the same or similar components. In the step S410, after the RAID is established, the CPU accesses and executes an operating system program of the RAID via the storage device interface to launch an operating system. In the step S420, when the operating system program is executed, the operating system maintains the storage device interface via the CPU.

The sequence of the steps S310, S320, S330, S340, S410 and S420 are not limited herein, and the details of the steps S310, S320, S330, S340, S410 and S420 can be referred to the embodiments shown in FIG. 1 and FIG. 2, which is omitted herein.

In sum, in the method for virtualizing a RAID of a computer system, after the computer system finishes the POST, it establishes the storage device interface via the CPU according to the array configuration. Thus, the RAID can be established via firmware before the operating system is loaded, which can establish the RAID without increasing cost of the hardware, and improve efficiency of the storage devices. Moreover, the RAID in use or relating functions can be added by updating an array drive.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A method for virtualizing a redundant array of independent disks (RAID) of a computer system, wherein the computer system includes a plurality of storage devices and a central processing unit (CPU), comprising following steps:
establishing a storage device interface via the CPU after the computer system is powered on and a power-on self-test (POST) is executed, wherein the storage device interface integrates the storage devices into at least one RAID according to an array configuration;
accessing the storage devices by the CPU via the storage device interface after the RAID is established;
determining an access mode of the storage devices by the CPU according to a level of the RAID when the CPU receives a storage device access instruction; and
establishing a user interface by the CPU according to a system program of the RAID.

2. The method for virtualizing the RAID of the computer system according to claim 1, wherein the method further includes:
accessing and executing an array driving program by the CPU, wherein the array driving program establishes the storage device interface according to the array configuration.

3. The method for virtualizing the RAID of the computer system according to claim 2, wherein the step of accessing and executing the array driving program by the CPU includes:
executing a boot loader program by the CPU to launch a boot loader after the POST is finished, wherein the boot loader initializes the computer system; and
accessing and executing the array driving program by the boot loader via the CPU when the boot loader program is executed.

4. The method for virtualizing the RAID of the computer system according to claim 2, wherein the step of accessing and executing the array driving program by the CPU includes:
executing a basic input output system (BIOS) program by the CPU to launch a BIOS; and
accessing and executing the array driving program by the BIOS via the CPU when the BIOS program is executed.

5. The method for virtualizing the RAID of the computer system according to claim 2, wherein the step of accessing and executing the array driving program by the CPU includes:
executing an unified extensible firmware interface (UEFI) program by the CPU to launch an UEFI; and
accessing and executing the array driving program by the UEFI via the CPU when the UEFI program is executed.

6. The method for virtualizing the RAID of the computer system according to claim 1, wherein the step of establishing the user interface by the CPU according to the system program of the RAID includes:
accessing and executing an operating system program of the RAID by the CPU via the storage device interface to launch an operating system after the RAID is established.

7. The method for virtualizing the RAID of the computer system according to claim 6, wherein the method further includes:
maintaining the storage device interface by the operating system via the CPU when the operating system program is executed.

8. The method for virtualizing the RAID of the computer system according to claim 7, wherein the method further includes:
accessing and executing a first array driving program by the CPU, wherein the first array driving program establishes the storage device interface according to the array configuration.

9. The method for virtualizing the RAID of the computer system according to claim 8, wherein the step of maintaining the storage device interface via the CPU includes:
accessing and executing a second array driving program by the operating system via the CPU when the operating system program is executed, wherein the second array driving program establishes the storage device interface to maintain the storage device interface according to the array configuration.

10. The method for virtualizing the RAID of the computer system according to claim 1, wherein the step of combining the storage devices to at least one RAID according to the array configuration includes:
scanning devices by the storage device interface of the CPU to confirm device information of the storage devices;
accessing the array configuration by the CPU to determine whether the storage devices are recorded in the array configuration;
setting a connection relation of the storage devices by the CPU according to the array configuration to connect the storage devices to form at least one RAID when the storage devices are recorded in the array configuration; and
regarding the storage devices as an independent storage devices by the CPU when the storage devices are not recorded in the array configuration.
